(19) United States
(12) Patent Application Publication
(10) Pub. No.: US 2010/0216392 A1
(43) Pub. Date: Aug. 26, 2010

(54) Configurable Module

(75) Inventors: Tristan James Barkley, Suffolk (GB); Martin Orrell, Bedfordshire (GB); Ibrahim Al Rashdan, Cambridge (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: THE TECHNOLOGY PARTNERSHIP PLC, Hertfordshire (UK)

(21) Appl. No.: 12/678,643

(22) PCT Filed: Sep. 17, 2008
(86) PCT No.: PCT/GB2008/003120

§ 371 Date: Mar. 17, 2010

(30) Foreign Application Priority Data
Sep. 17, 2007 (GB) 0718118.3
Aug. 27, 2008 (GB) 0815579.8

(51) Int. Cl. H04H 20/71

(52) U.S. Cl. 455/3.03

(57) ABSTRACT

A configurable module adapted for coupling to a host device comprises a stored user interface which is uploadable to the host device when it is coupled to the module. The user interface allows the module to be configured via the host device. The module may be coupled to a plurality of different host devices, including devices having a Graphical User Interface, such as a mobile phone, PDA, and laptop or personal computer. The module may be a digital audio broadcast (DAB) module including a DAB receiver. Alternatively, the module may include a wireless transceiver, such as a short range point to point, point to multi-point, or mesh wireless transceiver, for coupling the module to a network of wireless nodes, which may be the same or different. This module can also function when not coupled to a node, if configured by the host device or from prior connection with a node.

### FIELD OF THE INVENTION

The present invention relates to electronic devices and in particular to DAB radio modules and short range point to point, point to multi-point and mesh wireless systems.

### BACKGROUND TO THE INVENTION

Digital audio broadcast (DAB) to the Eureka 147 Standard is a radio broadcast system designed to deliver high quality digital audio information together with associated programme data. It is also capable of delivering high rate data services. Uptake of DAB in the audio market has however been slow, largely due to the high cost of receivers relative to the perceived benefit over frequency modulation (FM) radio.

However, significant interest has emerged recently from service providers wishing to offer data services such as news, sport and other multi-media information via a broadcast system. The interest derives from the substantially lower cost of broadcasting such information to a large number of users as compared with point to multi-point delivery via mobile networks such as GSM, GPRS and 3G, WiFi and WIMAX.

Further opportunities are perceived if a return data channel could be used with DAB. Higher value services, such as used in e-commerce, can be delivered with the return channel used for service selection and purchase transactions. The return channel could be provided by the public switched telephone network (PSTN) or for mobile users using Global System for Mobile Communications (GSM), General Packet Radio Service (GPRS) Bluetooth or WiFi.

Whilst the potential benefits of DAB as described above are recognised, no-one has yet solved the problem of providing a DAB module (i.e. battery powered) offering the variety of features which make DAB attractive but which is also conveniently portable. This is because the cost and size of first generation components/antenna and their inherent power consumption is too high and because DAB offers such a wide range of features. The same is true of other digital broadcast standards like DVB-H.

Similar considerations are relevant to other portable electronic devices. For example, there is a demand for ever greater richness of service to be available on mobile telephones but there is also a drive for miniaturisation.

Many standard and proprietary short range point to point, point to multi-point and mesh wireless systems exist where there are a plurality of wireless nodes in the system.

The nodes may be stationary or moving and are normally within range of at least one other node such that the transfer of information either in one direction or bidirectionally is possible across the nodes to and from nodes as well as across the network of nodes to a host device such as a PC, laptop computer, Personal Digital Assistant (PDA), a mobile phone or a custom device.

The functionality of the host may include a means of control, monitoring, display and storage, processing and as a gateway to other networks such as the public switched telephone network (PSTN), Global System for Mobile Telecommunications (GSM), General Packet Radio Services (GPRS) Bluetooth or WiFi.

The nodes in such systems may simply be wireless nodes to fill in gaps in the network of nodes such that communication across the network is possible and/or reliable. In more complex systems the nodes may also be part of, or connected to, a node host device and act as the wireless communications link between node host devices. Alternatively, the nodes may be connected to conveniently located node host devices in order to form a connected network of nodes. Examples of node host devices include devices from sensor, global and local positioning, identification, security and asset tracking applications.

The functionality of the nodes may also include a gateway to other networks such as the public switched telephone network (PSTN), Global System for Mobile Telecommunications (GSM), General Packet Radio Services (GPRS) Bluetooth or WiFi.

The benefits of such wireless systems include small physical size, low cost, low power and coverage of a large area of static and/or moving nodes with a relatively short range wireless technology. An additional benefit of such systems is that, due to the short range nature of the wireless link, suitable wireless technologies can typically be found in the license free industrial, scientific and medical (ISM) radio bands.

To maintain these benefits the nodes do not normally include a user interface (UI) and do not have a means of display or direct user input. These functions are instead achieved via the system host device.

In cases where proprietary wireless technologies are used then the system or node host devices may also require a means of interfacing to the proprietary wireless technology in question. This can limit the availability of suitable host devices and increase the cost of these.

Portability of the system host device is often desirable when the nodes are installed in locations that are normally remote from the system host device and, in particular, where the nodes can move location.

### SUMMARY OF THE INVENTION

According to the present invention there is provided a configurable module adapted to be coupled to a host device, comprising a stored user interface which is uploadable to the host device when it is coupled to the module, the user interface allowing the module to be configured via the host device.

The module is preferably adapted such that it can be coupled to a range of host devices, in particular host devices having a Graphical User Interface (GUI). For example the host device may be a mobile phone, Personal Digital Assistant (PDA), a laptop computer or a PC.

The module is preferably able to function when not coupled to a host device, the host device merely being used to configure the module for stand alone operation. The module may include a Graphical User Interface (GUI) or user controls. Preferably, the module has an on/off switch.

The present invention allows devices which are configurable or programmable but which do not require a GUI at all times to be made more readily portable, by virtue of the fact that the GUI is detachable.

In one example, the module may be a Digital Audio Broadcast module including a DAB (DAB or DVB-H) receiver. The module may be coupled to a host device using a wired connection or a wireless connection (for example Bluetooth). The user interface is embodied in software. In this example, the user interface may include information such as a list of radio stations, control scan functions, Dynamic Label Segment (DLS) information, menus or softkeys, in text or graphical form. The user interface may receive input, via key presses of the host for example, to navigate these menus etc.

In another example, the module may be a node-to-host bridge module connectable to one or more network nodes and one or more host devices. The module may include a low power, short range point to point, point to multi-point or mesh wireless transceiver. The module may be coupled to a network of wireless nodes capable of connecting with the module. One implementation of this example involves a temperature sensor node and a mobile phone host device. The user interface is embodied in software. In this example, the user interface may include information such as temperature sensor controls, timings for initiating sensor readings etc. The mobile phone can be used as the UI display and input device.

The module is preferably adapted so that it can be coupled to a plurality of the same or different nodes, in particular nodes having any combination of: wireless connectivity to increase the area covered; sensor capability, either local to the node or remotely; and/or local or global positioning features.

The module is preferably able to function when not coupled to a node, having been configured by the host device or from a prior to connection with a node.

### BRIEF DESCRIPTION OF THE DRAWINGS

Examples of the present invention will now be described in detail with reference to the accompanying drawings, in which: —

FIG. 1 is a system level diagram of a module according to the present invention;

FIG. 2 is a first example of a coupled module and host device;

FIG. 3 is a second example of a coupled module and host device;

FIG. 4 is a third example of a coupled module and host device, using a wireless connection;

FIG. 5 is a system level diagram of an alternative module configuration according to the present invention; and

FIG. 6 is a first example of a plurality of nodes coupled to a module and host device, using a wireless connection between the nodes and between a node and the module.

### DETAILED DESCRIPTION

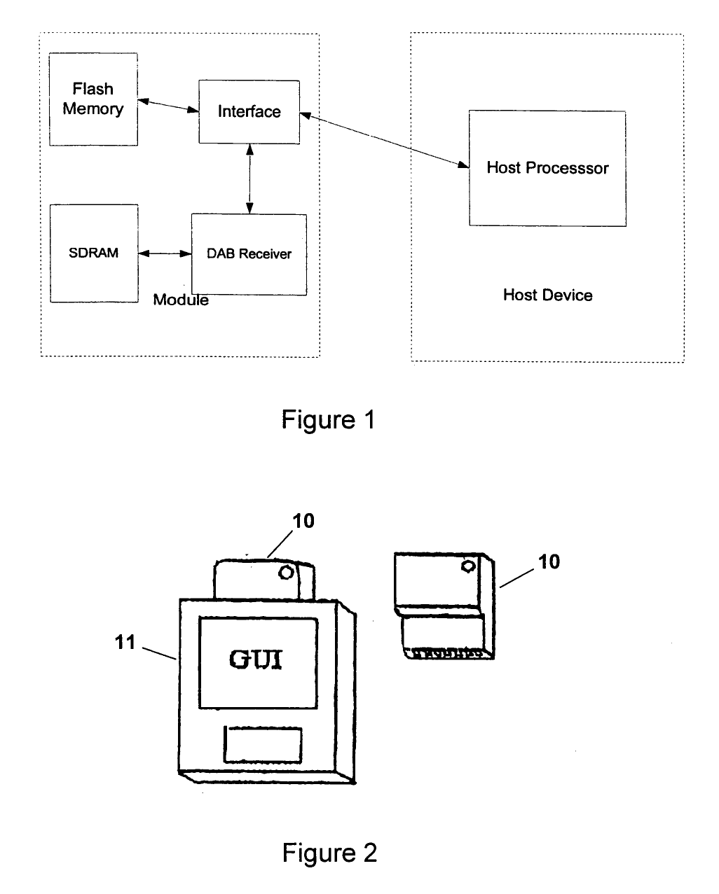

A system level view of a first embodiment in accordance with this invention is shown in FIG. 1. The module is a DAB module including a DAB receiver, and the host device may be a PDA, for example. Two types of storage medium are utilised in the module.

1) Flash memory: used to store the user interface independent of the host. The host device can then download the user interface (UI) stored in the module memory, for example flash. Hence the module can be used across different hosts and still have the same user interface. The host can also update the user interface by writing to the flash via the UI application. The UI application also validates the flash content using a checksum. Protecting the flash content is accomplished using a code word.

2) SDRAM: This memory is used by the receiver for processing system specific applications (e.g. cyclic buffers) and for storage purposes. This memory can also used by the host as a storage medium and a file system is implemented to manage this functionality. Intelligent management and use of this storage underlies the novel features and improvements of the realised module and UI.

The “interface” provides a communication channel between the host and the flash memory and between the receiver and host. The interface also provides a protection mechanism for the flash memory, prohibiting other applications residing in the host from accidentally writing to the flash. The mechanism is based on a code word approach. When plugging (or connecting using a wireless protocol) the module into the host a set-up application will be uploaded to the host interface prohibiting the interface from allowing any write operations to the flash. The set-up application also handles uploading the UI application. Unlocking the interface can be carried out using a code word which is sent from the UI application on the host to the interface. Hence, a write operation to the flash must be preceded by sending a code word to the interface to verify the operation. Upon completion of the write operation the UI application locks the flash memory by sending another code word to the interface. In the case of unplugging the module before locking the interface, the interface will remain unlocked, however, writing to the flash requires plugging in the module for the set-up application to lock the interface.

The device architecture allows the module to operate in two different modes, attachable and stand-alone. The attachable module uses the host device as a user interface terminal. To maintain consistency, the UI is stored in the module using a non-volatile memory. The user on the host device or using the module can activate the upload process. Alternatively, the user interface can be uploaded from the module to the host device automatically, i.e. without user intervention. The host device can detect the attached module via a mechanism dependent on the communication medium, and a request for UI transfer can be initiated by any of the devices. The download of the UI can be accomplished via a wired or wireless channel.

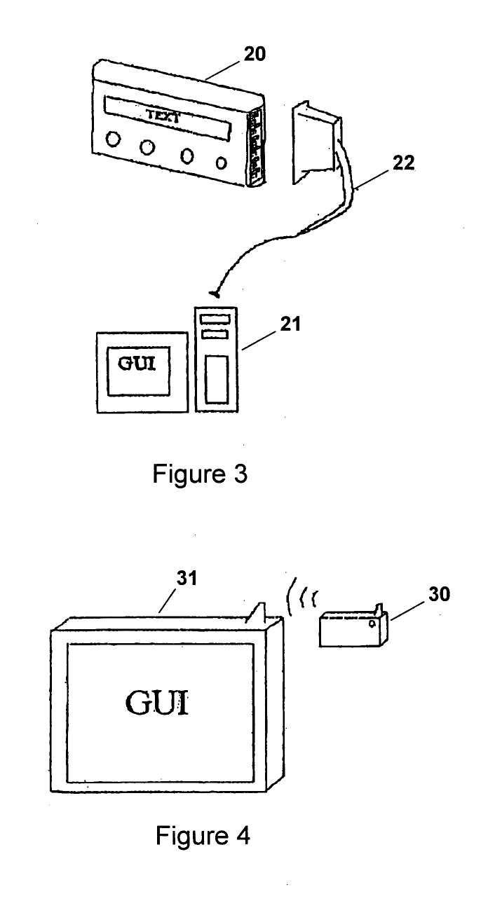

FIGS. 2, 3 and 4 each show a different type of connection between the host device and the module. In FIG. 2 the module 10 is plugged into the host device 11. In FIG. 3 the module 20 is connected to the host device via a cable. In FIG. 4 the module 30 is connected to the host device 31 using a wireless communications link.

The module also has the ability to record and save user preferences and configuration. These preferences can be loaded again to any host device to configure the UI and other system settings.

The downloadable UI creates not only consistency but uniformity in the module usage across different platforms capable of interpreting the UI without requiring any software add-ons or upgrades.

The module can be detached from the host device and still have the ability to operate as a stand-alone module powered by an integral battery, independent and self-sufficient. The module can have a small or no display, accompanied by entry buttons to provide a man machine interface. It may also, or only, have a power switch button. Changes in the module's state will be stored internally, giving the host device the ability to interrogate the module for its current status when attached to the host.

This allows the module to change its state independent of the host device, giving the user greater flexibility over the module's functionality.

Thus the module can be used with a host device to take advantage of the host user interface capabilities to set the module into a certain operating state. The module can then be detached and used standalone with the pre-set operational setting, for instance, to allow greater portability, lighter weight etc. Upon re-connection to a host, the host can detect the operating state of the module and UI control via the host can re-establish. Whilst disconnected the module state could be altered using the residual embedded controls, in particular the module has a power switch to allow it to be switched off. If switched on again it would resume the same operational state as prior to switch off, until re-connected to a host when state changes could be made.

In the example shown in FIG. 1 the module is a portable Digital Radio. The radio has a rich user interface capability for making possible advanced digital features such as record, replay and time-shift. The radio module is connectable to a mobile phone or personal digital assistant (PDA). For example on a Handspring Visor the module utilises the Springboard expansion slot. The Handspring provides an adequate platform to demonstrate the capabilities of the module and Digital Radio through its large graphic touch screen display.

The concept of a detachable device that has the ability to operate in a stand-alone mode, complemented by the concept of a stored UI which can be uploaded to a host device can be generalised to any device that can be considered as detachable/stand-alone. The example given above is of a Digital Radio receiver module (with headphones) used with a PDA as the UI host, the receiver capable of operating stand-alone when set up via the host and then detached. The invention is, for example, equally applicable to an MP3 player and a PDA.

Another example is a mobile telephone capable of receiving multimedia data, such as a 2G, 2.5G or 3G telephone, with a host device such as a PC. It is undesirable to have a large graphic display on a mobile telephone, principally for reasons of portability. The telephone could be coupled to a PC or a GUI in a telephone box via wireless link, such as Infrared or Bluetooth, to allow the user to access information or configure the telephone.

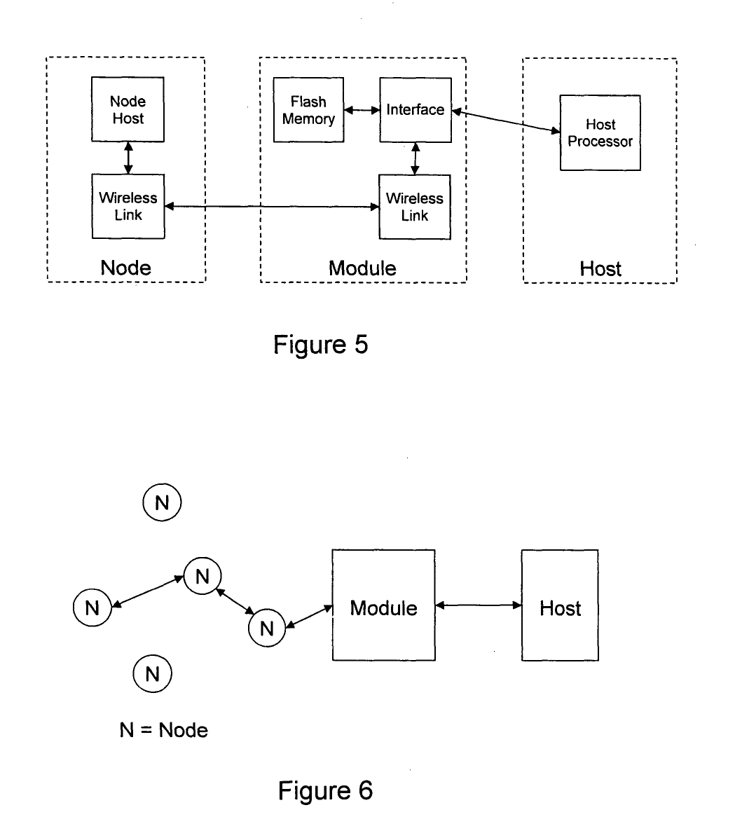

A system level view of a wireless node connected to a node-to-host bridge module which in turn is coupled to a mobile phone is shown in FIG. 5.

The node has a low power, short range wireless communications link, which may function in two modes, as follows:
1) As a communications link in a network of wireless nodes and at least one node-to-host bridge module.
2) As a communications link in a network of wireless nodes and at least one node-to-host bridge module which is connected to a node host device.

A node may also have a node host device; an example node host device from a sensing application would be a temperature sensor. The node host device may also include connectivity to other devices and systems, for example, where the same wireless communications link in the node may also be used to connect to a remote sensor.

The node-to-host bridge module configuration has the same flash memory and interface elements as described in FIG. 1. However, in place of the DAB Receiver and SDRAM elements the node-to-host bridge module has a wireless low power, short range wireless communications link suitable for connecting to at least one node, as shown in FIG. 6.

The node-to-host bridge module configuration also allows the module to operate in attachable and stand-alone modes. Apart from the Digital Radio element the operation of the module and host is the same in all other respects as the preceding description with the following additions:

The node-to-host bridge configured module can be used with a plurality of nodes with the same or different node host devices. The node-to-host bridge module can also be used with different networks of nodes.

The node-to-host bridge configured module can be used stand-alone from the nodes and connect to the host to set up the user interface UI and configure the module ready for connection to the network of nodes. For example, specifying which node, from a plurality of nodes in a network, it is to communicate with once in range of any node in the network.

The node-to-host bridge configured module can be used stand-alone from the host and connected to the network of nodes in, for example, cache mode. For example, having been configured to communicate with a particular node to retrieve sensor readings the module may connect directly or indirectly to any or all of the network of nodes and retrieve the information for later viewing and/or manipulation via the UI once connected to the host device.

The node-to-host bridge configured module can be used stand-alone from the both host and nodes. For example, having been configured to communicate with a particular node to retrieve information, such as sensor readings, the module may be configured to search for a connection with the network of nodes although it is not in range of any node, connection being established once in range.

In the example shown in FIG. 5 the node is a temperature sensor and host device a mobile phone. The wireless link is a proprietary ISM band link and the interface between the module and phone is Bluetooth. A large number of small, low cost, low power temperature sensing nodes with no integrated UI can be easily configured and interrogated without the need for expensive and potentially bulky specialist equipment or cabling. The ubiquitous mobile phone can be used as the UI display and input device, with a single ISM to Bluetooth bridge version of the module, to communicate with any or all of the sensor nodes.

1. A module adapted to be coupled to a host device, the module comprising a user interface which is stored in a memory of the module and which is uploadable to the host device when it is coupled to the module, the user interface allowing one or more functions of the module to be accessed via the host device,
wherein the module further comprises a stored set-up application which is uploadable when required to the host device to manage upload of the user interface to the host device and to prohibit unauthorized write operations by the host device to the memory of the module.

2. A module according to claim 1, in which the module is adapted such that it can be coupled to a plurality of different host devices.

3. A module according to claim 1, in which the module is adapted such that it can be coupled to a plurality of different host devices.

4. A module according to claim 1, in which the module is able to function when not coupled to a host device.

5. A module according to claim 1, including a Graphical User Interface (GUI).

6. A module according to claim 1, in which the module does not include a Graphical User Interface (GUI).

7. A module according to claim 1, adapted to be releasably coupled to a host device via a wired connection.

8. A module according to claim 1, adapted to be coupled to a host device via a wireless connection.

9. A module according to claim 1, in which the user interface is adapted to permit one or more functions of the module to be at least temporarily configured by the host device.

10. A module according to claim 9, in which the user interface is adapted to permit one or more functions of the device to be configured or downloaded by the host device for operation when decoupled from the host device.

11. A module according to claim 1, which is adapted to upload the user interface to a host device without user intervention.

12. A module according to claim 1, in which the user interface is adapted to be updated by a host device.

13. A module according to claim 1, including a broadcast receiver.

14. A module according to claim 13, wherein the broadcast receiver is a Digital Audio Broadcast (DAB) receiver.

15. A module according to claim 1, including a wireless transceiver for coupling the module to a network of wireless nodes capable of connecting with the module.

16. A module according to claim 15, wherein the wireless transceiver is a short range point to point, point to multi-point, or mesh wireless transceiver.

17. A module according to claim 15, wherein the module is adapted to be coupled to a plurality of the same or different nodes.

18. A module according to claims 15, wherein the module is able to function when not coupled to a node, having been configured by the host device or from prior connection with a node.
